(19) United States
(12) Patent Application Publication
(10) Pub. No.: US 2014/0242321 A1
(43) Pub. Date: Aug. 28, 2014

(54) Bridging Films for Porous Thin Films

(71) Applicant: Svana Nanotechnologies, Inc., Sunnyvale, CA (US)

(72) Inventors: Siglinde Schmid, San Jose, CA (US); Melissa Fardy, Belmont, CA (US); J. Wallace Parce, Palo Alto, CA (US); Keith Rieken, Saratoga, CA (US); Benjamin Wang, Mountain View, CA (US); Kevin Krogman, Santa Clara, CA (US)

(73) Assignee: Svana Nanotechnologies, Inc., Sunnyvale, CA (US)

(21) Appl. No.: 14/267,944

(22) Filed: May 2, 2014

Related U.S. Application Data
(63) Continuation of application No. PCT/US12/62892, filed on Nov. 1, 2012.
(60) Provisional application No. 61/702,122, filed on Sep. 17, 2012.
(60) Provisional application No. 61/663,556, filed on Jun. 23, 2012.
(60) Provisional application No. 61/557,840, filed on Nov. 9, 2011.

(51) Int. Cl. C08J 7/04; C08J 5/18

(52) U.S. Cl. CPC C08J 7/042; C08J 5/18; C08J 2367/02; C08J 2337/00
USPC 428/68; 428/316.6; 428/304.4; 428/141; 428/142; 427/372.2; 264/322

(57) ABSTRACT

The disclosure provides methods and materials for preparing bridging films. In one aspect, the bridging films are non-porous and are suitable for protecting adjacent porous films. For example, the bridging films contact a porous film and protect the porous film from transfer of gases and/or liquids into the pores of the porous film. In another example, bridging films protect the porous film from abrasion.

### CROSS-REFERENCE TO RELATED APPLICATIONS

This application claims priority to PCT/US12/62892, filed Nov. 1, 2012, which application claims priority to U.S. Patent Applications Ser. No. 61/702,122, filed Sept. 17, 2012, Ser. No. 61/663,556, filed Jun. 23, 2012, and Ser. No. 61/557,840, filed Nov. 9, 2011; the contents of all such applications are incorporated herein by reference.

### INTRODUCTION

Porous thin films are known in a variety of contexts. For example, porous thin films are useful as low-K dielectric materials in electronic applications, as protective coatings, as selective barriers against liquid and gaseous contaminants or pathogens, as controlled release layers, as separation aids for gases and liquids, as scaffolds for sensing devices, and as scaffolds for synthetic biomaterials. Porous thin films can have pores that are interconnected (i.e., an open cell structure) or non-interconnected (i.e., a closed cell structure), and are measured on a variety of length scales, such as nanometer or micrometer scales.

Because of the variety of applications that are suitable for porous thin films, controlling the properties of such films is important and is an active area of research. It is also important to control the interaction of porous thin films with their environment—i.e., surrounding films and the like.

### SUMMARY

In an aspect, there is provided a composite comprising, in sequence: (a) a first porous film comprising a layer by layer deposited film; (b) a non-porous first bridging layer; and (c) a third layer selected from a first laminating layer, a second porous film comprising a plurality of bilayers, and an optically clear substrate, wherein the first bridging layer forms a barrier against transmission of contaminants, EM radiation, electrons, or ions, into the first porous film from the third layer, or wherein the first bridging layer provides structural integrity to the composite.

In embodiments:

the first porous film comprises layers of nanoparticles alternating with layers of polyelectrolyte;

the first porous film selectively reflects EM radiation or acts as a selective EM filter;

the first bridging layer is chemically crosslinked, physically crosslinked, or is not crosslinked;

the contaminant is selected from small organic molecules, water, ions, salts, acids, bases, liquids, and gases;

the composite further comprises a non-porous second bridging layer contacting the first porous film;

the third layer is a first laminating layer;

the first laminating layer comprises PVB having a first smooth side and second side selected from smooth and textured;

the composite further comprises an optically clear substrate contacting the first porous film;

the composite further comprises a non-porous second bridging layer contacting the first porous film;

the composite further comprises an optically clear substrate contacting the second bridging layer;

the second bridging layer is positioned between the first porous film and a second laminating layer;

the second bridging layer, the second laminating layer, or both contain an EM absorbing material;

the composite further comprises a first optically transparent substrate contacting the first laminating layer and a second optically transparent substrate contacting the second laminating layer, wherein the second optically transparent substrate optionally comprises an EM absorbing material;

the composite further comprises a hardcoat contacting the second bridging layer and an optically clear substrate contacting the third layer;

the second bridging layer is not crosslinked and comprises PET;

a PET layer is not contacting the first porous film;

In another aspect, there is provided a method for forming the composite film of the first aspect, the method comprising: applying the first bridging layer to the third layer; curing the first bridging layer to form a first crosslinked hardcoat; and applying the first porous film to the bridging layer in a layer-by-layer process.

In embodiments:

the method comprises applying a second bridging layer to the first porous film, and curing the second bridging layer to form a second crosslinked bridging layer (i.e., a hardcoat layer);

the method comprises: applying a second laminating layer to the second bridging layer; optionally applying a first optically clear substrate to the first laminating layer; and optionally applying a second optically clear substrate to the second laminating layer; and

the method comprises applying a non-porous sealant to the edges of the first porous film, the first bridging layer, and the third layer.

In another aspect, there is provided a method for making a modified PVB layer, the method comprising heating a PVB layer to above the T_{g} of the PVB contacting a first side of the PVB layer with a smooth surface, contacting a second side of the PVB layer with a second surface, and applying pressure to the PVB layer.

In embodiments:

the second surface is a textured surface; and

the second surface is a smooth surface.

In another aspect, there is provided herein a composite film comprising: (a) a first group of bilayers forming a first porous film; and (b) a bridge film, wherein the bridge film is disposed on top of the first porous film and is non-porous or has a closed pore structure.

In embodiments:

the composite film further comprises a second group of bilayers that form a second porous film;

the bridge film is disposed between the first porous film and second porous film;

the bridge film comprises a polymer having a molecular weight of greater than 500 kDa, or a molecular weight of less than 500 kDa;

the polymer is a polyelectrolyte;

the bridge film comprises nanoparticles having an aspect ratio greater than 10 or less than 0.1;

the nanoparticles are selected from clay nanoparticles, graphene, carbon nanotubes, wires and sheets of metals, metal oxides, metal sulfides and derivatives and combinations thereof;

the nanoparticles are polyelectrolytes;

the bridge film comprises a plurality of bilayers;

the bilayers of the bridge film comprise at least two polyelectrolytes;

at least one of the polyelectrolytes is selected from a polymer having a molecular weight of greater than 500 kDa, nanoparticles having an aspect ratio of less than 0.1, and nanoparticles having an aspect ratio of greater than 10;

the bridge film comprises crosslinked acrylates

the composite further comprises a laminating material contacting the bridge film;

the first porous film is disposed on a substrate;

the substrate contacts a laminating material;

the laminating material contacts a glass layer;

a glass layer contacts the laminating material;

the laminating material comprises adhesives, thermosets, thermoplastics, elastomers, and combinations or copolymers thereof;

the laminating material comprises PVB;

the first porous film is a dichroic mirror;

the composite is part of an article, the article further comprising a substrate and one or more laminating materials;

the bridge film blocks light transmission (selectively or non-selectively), electron flow, permeation or flow of gases and/or liquids, or ion flow, or combinations thereof;

the bridge film is denser than the first porous film or the bridge film is thicker than the first porous film and thereby provides additional weight to the composite;

the bridge film prevents mechanical degradation of the first porous film;

the bridge film prevents dielectric breakdown when an electric field is applied across the composite film;

the bridge film reduces surface roughness in the first porous film; and

the bridge film has a porosity of less than 10%.

In another aspect, there is provided a laminated structure comprising: (a) a plurality of bilayers forming a porous film; (b) a bridge film contacting the porous film and comprising at least one polyelectrolyte; and (c) a top layer selected from a laminating layer and an encapsulation layer, wherein the top layer contacts the bridge film.

In embodiments:

the polyelectrolyte of the bridge film is selected from a polymer having a molecular weight greater than 500 kDa, nanoparticles having an aspect ratio greater than 10, and nanoparticles having an aspect ratio less than 0.1;

the porous film has a thickness T1, and wherein the polyelectrolyte of the bridge film extends into a portion of the porous film not exceeding 5% of T1;

the bridge film prevents the material of the top layer from contacting the porous film;

the bridge film has a porosity less than 10%;

the top layer is a laminating layer comprising adhesives, thermosets, thermoplastics, elastomers, and combinations or copolymers thereof;

a laminating layer comprises PVB; and

the top layer is an encapsulation layer comprising a cross-linkable material.

In another aspect, there is provided a method for preparing a composite film, the method comprising: (a) preparing a porous film comprising a polymer; and (b) depositing on the porous film a bridging film, wherein the bridging film is non-porous or has a closed pore structure.

In embodiments:

the porous film further comprises nanoparticles;

the nanoparticles and polymer are arranged in bilayers, wherein each bilayer comprises a monolayer of nanoparticles and a layer of polymer;

the bridging film comprises a polyelectrolyte selected from a polymer having a molecular weight greater than 500 kDa, nanoparticles having an aspect ratio greater than 10, and nanoparticles having an aspect ratio less than 0.1;

the method further comprises depositing a second porous film on the bridging film;

the method further comprises drying the bridging film prior to depositing the second porous film;

the bridging film has a density that is 50% greater than the porous film; and

the bridging film has a porosity less than 10%.

In another aspect, there is provided a composite film comprising: a substrate; a thin film disposed on the substrate; a bridge film disposed on top of the thin film, wherein the bridge film is non-porous or has a closed pore structure, and wherein the bridge film is hydrophilic.

In embodiments:

the bridge film possesses a polar characteristic and retards migration of plasticizers;

the bridge film is a crosslinked material or a thermoset material; and

the storage modulus of the bridge film is greater than the loss modulus at strain rates of 1 rad/s at standard temperature and pressure.

In another aspect, there is provided: a composite film comprising a first material, a second material, and a bridging film disposed between the first material and second material, wherein the first material is porous, the second material comprises a hydrophobic small molecule, and the bridging film prevents migration of the hydrophobic small molecule from the second material to the first material.

In embodiments:

the bridging film is hydrophilic;

the bridging film is crosslinked, or the bridging film is not crosslinked;

the bridging film comprises at least about 3, 5, or 15 wt % water at standard temperature and pressure;

the first material is degraded in the presence of the hydrophilic small molecule;

the degradation is selected from physical, optical, or mechanical; and

the bridging film has a refractive index (RI) that differs by less than 10% from the RI of the first material or the RI of the second material.

These and other aspects will be apparent from the disclosure provided below, including the examples, claims, and figures.

### DEFINITIONS

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein. It is understood that the present disclosure supersedes any disclosure of an incorporated publication to the extent there is a contradiction.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The term “typically” is used to indicate common practices of the invention. The term indicates that such disclosure is exemplary, although (unless otherwise indicated) not necessary, for the materials and methods of the invention. Thus, the term “typically” should be interpreted as “typically, although not necessarily.” Similarly, the term “optionally,” as in a material or component that is optionally present, indicates that the invention includes instances wherein the material or component is present, and also includes instances wherein the material or component is not present.

As used herein, the term “substrate surface” (or sometimes simply “surface”), includes the surface of a substrate itself as well as the surface of any coatings deposited on the substrate. Thus, for example, when a material is deposited on a substrate surface, the material may be deposited directly onto the surface of the substrate itself, or the material may be deposited onto the surface of a coating disposed on the substrate.

As used herein, the term “porous” as in a “porous material” refers to a material containing pores (i.e., void regions), whether such pores are filled with another material or unfilled. That is, a porous material may contain pores that are unfilled (or, more likely, filled with an ambient gas such as air), partially filled with a pore-filling material, or completely filled with a pore-filling material.

As used herein the term “porous structure” refers to a network of interconnected cavities in a coating or thin film that is substantially occupied by air, water vapor, oxygen, nitrogen or other ambient gases. The porous structure is defined by the structure of the material of the thin film, e.g., by the layers of polymeric, monomeric and/or nanoparticle material that may be used to produce a layer-by-layer thin film.

As used herein, a “film” is a coating structure that comprises two or more individual “layers.” Thus, the term “layer” refers to a singular coating structure. Furthermore, the term “bilayer” refers to a singular coating structure comprising two layers. As used herein, however, the terms “bridging layer” and “bridging film” are used interchangeable. Use of either term is not intended to imply a structure that has a plurality of layers (i.e., a bridging film can consist of a single film as described herein) or a structure that is limited to a single layer (i.e., a bridging layer can contain multiple layers as described herein). These definitions apply unless otherwise indicated or a contrary meaning is clear from the context.

As used herein, the term “aspect ratio” as applied to nanoparticles and other materials refers to the ratio of the average width of the particle to the average thickness of the particle. For example, a particle material with an aspect ratio of 10 refers to a material with an average particle width that is 10 times greater than the average particle thickness. Similarly, a particle material with an aspect ratio of 0.1 refers to a material with an average particle width that is 0.1 times the average particle thickness.

Definitions of other terms and concepts appear throughout the detailed description below.

### DETAILED DESCRIPTION

In some embodiments, there is provided herein methods and materials for providing bridging films. A bridging film of interest contacts and protects one or more porous films as described herein. In some embodiments, the bridging film contacts a first material and a second material, wherein the first material is a material to be protected (e.g., a porous film), and wherein the second material is a material from which protection of the first material is required (e.g., a laminating layer).

In a first aspect, there is provided a composite comprising, in sequence: (a) a first porous film comprising layers of nanoparticles alternating with layers of polyelectrolyte; (b) a non-porous first bridging layer; and (c) a third layer selected from a first laminating layer, a second porous film comprising a plurality of bilayers, an optically clear substrate, and an encapsulating layer, wherein the first bridging layer forms a barrier against transmission of contaminants, EM radiation, electrons, or ions, into the first porous film from the third layer, or wherein the first bridging layer provides structural integrity to the composite.

In a second aspect, there is provided a method for forming the composite film of the first aspect, the method comprising: applying the first bridging layer to the third layer; curing the first bridging layer to form a first crosslinked hardcoat; and applying the first porous film to the bridging layer in a layer-by-layer process.

In a third aspect, there is provided a method for making a modified PVB layer, the method comprising heating a PVB layer to above the T_{g} of the PVB contacting a first side of the PVB layer with a smooth surface, contacting a second side of the PVB layer with a second surface, and applying pressure to the PVB layer.

As described in more detail herein, porous films comprising a plurality of bilayers can be prepared by LbL deposition of polyelectrolytes. For example, porous layers can be prepared using a polymer polyelectrolyte and a polyelectrolyte comprising nanoparticles with a moderate aspect ratio (e.g., nanospheres or the like). Porous layers can also be prepared using nanoparticles alone or from polymers alone. Other methods, including non-LbL methods, for preparing porous films are known and may also be employed here.

The porous films described herein are, in some embodiments, thin films. Such thin films may have average thicknesses of between 10 nm and 10 μm. For example, such thin films may have average thicknesses less than 10, 5, or 1 μm, or less than 750, 500, 250, 100, or 50 nm. Also for example, such thin films may have an average thickness of greater than 10, 50, 100, 250, 500, or 750 nm, or greater than 1 or 5 μm.

### MATERIALS FOR BRIDGING FILM

In some embodiments, the bridging films are prepared from a polymer material. In some embodiments, the polymer material is a high molecular weight polymer. By “high molecular weight” is meant that the polymer material has a molecular weight greater than 500 kDa, or greater than 600 kDa, or greater than 700 kDa, or greater than 800 kDa, or greater than 800 kDa, or greater than 900 kDa, or greater than 1 M Da, or greater than 2 M Da.

In some embodiments, lower molecular weight polymers can be used to prepare the bridging film. In some such embodiments, the bridging film is made thicker (compared to the films using higher molecular weight polymers) to provide the desired barrier properties as described herein. For example, the polymer material may have a molecular weight of less than 500 kDa but greater than 5 kDa, or greater than 10 kDa, or greater than 25 kDa, or greater than 50 kDa, or greater than 100 kDa, or greater than 200 kDa, or greater than 300 kDa, or greater than 400 kDa. In other embodiments, it is not necessary to use a thicker bridging film when the polymer material is low molecular weight. Bridging film thicknesses are described in more detail below.

In some embodiments, the bridging films are prepared depositing one or more monomers and initiating a polymerization of such monomer(s). Initiation can be, for example, using a thermal initiator (e.g., AIBN), a photoinitiator, or the like.

Examples of suitable polymer materials for the bridging film include polyelectrolytes (such as polydiallyldimethylammonium chloride, polyacrylic acid, sulfonated polystyrene, polyethyleneimine, polythiophenes, polyaniline, chitosan, carboxymethylcellulose, hyaluronic acid, polyvinylpyrollidone, polyvinylalcohol, and polyallylamine), polyacrylates, polymethacrylates, vinyl polymers such as polystyrene, polyethylene, polypropylene, polyvinylbutyral (PVB), polysiloxanes, polysilazanes, and the like, as well as combinations and copolymers thereof. In some embodiments, the bridging film comprises an ammonium acryloyldimethyltaurate/VP copolymer such as Aristoflex® AVC (marketed by Clariant). In some embodiments, the bridging film is prepared from more than one of the materials mentioned herein, such as a film prepared from alternating layers of two such materials. Where the bridging film is prepared from one or more monomers, such monomers can be selected from those that provide the polymers described above (e.g., acrylic acid, styrene, etc.).

In some embodiments, the polymer of the bridging film is a crosslinked material. Such crosslinked material may be applied as a crosslinkable material. Crosslinkable materials include high molecular weight polymers as well as low molecular weight polymers (including oligomers or monomers). Subsequently, a crosslinking step can be employed to crosslink the crosslinkable material and form the crosslinked bridging film. For example, crosslinking can be carried out by the application of energy in the form of UV or other electromagnetic energy. Alternatively or in addition, crosslinking can be carried out by the application of heat energy (i.e., raising the temperature of the pre-bridging film). Alternatively or in addition, a crosslinking agent can be included in the bridging film, wherein the crosslinking agent can be initiated by heat, UV, time, or other methods. Suitable crosslinking agents include peroxides and diazo compounds. Crosslinking of the bridging film can be carried out directly after deposition of the bridging film or can be carried out after deposition of other layers and components. Crosslinked bridging films are useful as hardcoat layers, and maybe referred to herein as such.

Examples of crosslinkable materials include polyelectrolytes (such as polydiallyldimethylammonium chloride, polyacrylic acid, sulfonated polystyrene, chitosan, polyethyleneimine, polythiophenes, polyaniline, carboxymethylcellulose, hyaluronic acid, polyvinylpyrollidone, polyvinylalcohol, polyallylamine), thermoplastics and thermosets (such as acrylates, methacrylates, urethanes, cyanoacrylates, epoxy formulations, vinyls and their polymers), polystyrene and derivatives (e.g., crosslinked with divinylbenzene), polyethylene, polypropylene, polyvinylbutyral (PVB), polysiloxanes, polysilazanes, and the like, as well as combinations and copolymers thereof).

In some embodiments, the bridging film is a polymeric material that is not crosslinked. Non-crosslinked polymers have number average molecular weights that may be less than 2 M Da, or less than 1 M Da, or less than 500,000 Da, or less than 300,000 Da, or less than 150,000 Da, or less than 100,000 Da, or less than 75,000 Da, or less than 50,000 Da, or less than 25,000 Da, or less than 10,000 Da, or less than 5,000 Da.

In some embodiments, the polymer of the bridging film is highly polar. In some embodiments, the functional groups of the polymer of the bridging film are highly polar. In some embodiments, the polymer of the bridging film is highly hydrophilic. In some embodiments, the polymer of the bridging is crosslinked, but in an un-crosslinked form the polymer is water soluble. In some embodiments, the bridging film as incorporated into a composite material comprises at least 15 wt % water, or at least 10 wt % water, or at least 5 wt % water, or at least 3 wt % water, or at least 2 wt % water. These weight percentages are measured at standard temperature and pressure.

In some embodiments, the bridging film is prepared using a nanoparticle material. In some embodiments, nanoparticles suitable for the bridging film have a high aspect ratio—i.e., one that is greater than 10, or greater than 100, or greater than 1000. In some embodiments, nanoparticles suitable for the bridging film have a low aspect ratio—i.e., one that is less than 0.1, or less than 0.01, or less than 0.001. In some embodiments, nanoparticles suitable for the bridging film have a moderate aspect ratio—i.e., one that is between 0.1 and 10, or between 0.5 and 7.5, or between 1 and 5. Examples of suitable nanoparticle materials include clays, graphene, carbon nanotubes, carbon filaments, silver nanowires, silicon nanowires, polymeric nanotubes or sheets, and the like, as well as derivatives and combinations thereof. Such nanoparticles are, in some embodiments, insoluble and can be prepared as a dispersion in a solvent. For example, clay nanoparticles can be prepared by ultrasonification in a solvent. Examples of suitable clay materials include montmorillonite, laponite, bentonite, cloisite and the like.

As described in more details below, LbL methods are suitable for depositing polyelectrolyte materials as the bridging film. The above-described materials (high and low molecular weight polymers, crosslinkable polymers, and high and low aspect ratio nanoparticles) can be used in LbL methods when such materials are polyelectrolytes or can otherwise participate in complimentary binding. For example, polyelectrolytes contain multiple ionic charges, and can be prepared by incorporating charged moieties (e.g., carboxylic acids, quaternary amines, etc.) into the chemical structure.

### METHODS OF FORMATION/DEPOSITION

As mentioned previously, in some embodiments, the bridging film is deposited using LbL deposition, and the film comprises at least two polyelectrolytes. LbL deposition involves alternating application of at least a pair of complementary deposition materials. By “complementary” is meant that the two materials contain complementary binding groups that are able to form binding pairs. For example, such binding groups include ion-ion binding pairs, hydrogen bonding pairs, ligand-receptor binding pairs, and groups that are capable of forming covalent bonds. Because the driving force for layer formation involves the complementary binding pairs, the LbL deposition process is self-limiting. For example, once a monolayer of a first polyelectrolyte has formed on the surface, additional film-forming material (having the same binding group) tends not to bind to the surface. Deposition of the complementary material, however, results in formation of a layer comprising second electrolyte groups that bind to the first polyelectrolyte groups. The charge-reversal process can be continued indefinitely to build a film containing a plurality of individual layers. Each pair of layers (comprising complementary polyelectrolytes) is referred to as a “bilayer.”

Polymer materials, crosslinkable materials, and high- or low-aspect ratio nanoparticle materials as described herein can be used in LbL deposition methods when such materials are polyelectrolytes. For example, carbon nanotubes may be made into a polyelectrolyte through an acid treatment which breaks carbon-carbon bonds to form carboxylic acid groups which can be subsequently ionized at an appropriate pH. Graphene can be converted to graphite oxide with an oxidizing treatment. Nanoparticle surface functionalization, such as silane or phosphonate treatments can be used to impart ionic moieties onto the surface. Use of ionic surfactants may also be used to impart electrostatic charges to a nanoparticle.

In some embodiments, the bridging film is prepared using LbL deposition of two polyelectrolyte materials, wherein at least one polyelectrolyte is a polymer as described herein having high molecular weight. The second polyelectrolyte can be, for example, a second high molecular weight polymer, a low molecular weight polymer, or high- or low-aspect ratio nanoparticles.

In some embodiments, the bridging film is prepared using LbL deposition of two polyelectrolyte materials, wherein at least one polyelectrolyte is high- or low-aspect ratio nanoparticles. The second polyelectrolyte can be, for example, a high or low molecular weight polymer. Alternatively, the second polyelectrolyte can be a different type of high- or low-aspect ratio nanoparticles.

In some embodiments, the bridging film is prepared using LbL deposition of two polyelectrolyte materials, wherein at least one polyelectrolyte is a crosslinkable polymer or prepolymer (i.e., a crosslinkable polymer precursor such as a monomer or oligomer) as described herein. The second polyelectrolyte can be, for example, another polymeric material, either having high or low molecular weight. Alternatively, in some embodiments the second polyelectrolyte can be high- or low-aspect ratio nanoparticles.

Where LbL methods are used for preparation of a bridging film, the number of bilayers needed for the bridging film is dependent upon the types of materials used as well as the properties that are desired for the bridging film. In some embodiments, the number of bilayers for the bridging film will be between 1 and 1000, or between 1 and 100, or between 1 and 50, or between 1 and 10. For example, the number of bilayers in the bridging layer can be between 1 and 20, or between 1 and 10, or between 1 and 5.

In some embodiments, and as described herein, the bridging film can be prepared using non-LbL techniques. For example, in some embodiments, the bridging film is prepared by depositing a single layer of a polymer material, microparticle material, nanoparticle material, monomer material, or combination thereof. In some embodiments, the bridging film is a hardcoat that is prepared from a hardcoat formulation, which may comprise monomer and/or oligomer as well as an initiator such as a photoinitiator, etc. In some embodiments, the thickness of this material is greater than 1 micron, or greater than 2 microns, or greater than 3 microns, or greater than 5 microns or greater than 10 microns. Such deposition can be carried out in any convenient manner, such as spray, spin, casting, dip, rod coating, gravure coating, microgravure, slot die coating, other deposition methods and combinations of thereof known in the art. In some embodiments, the polymer, microparticle, nanoparticle, or combination thereof is selected such that the refractive index can be matched to an encapsulating or laminating material. The bridging film may also be prepared using non-electrolyte materials. These materials can also be incorporated with other materials such as thermosetting materials, solvents, etc. Furthermore, multiple layers can be deposited using classic coating technologies (i.e. not using complementary binding groups and layer-by-layer methods). Examples of such materials include epoxy layers, carbon black, etc.

In some embodiments, a bridging film is prepared by depositing a single layer of low molecular weight polymer and/or monomer, where such material is optionally crosslinkable as described herein. The bridging film is then crosslinked as described herein. Methods for crosslinking are described in more detail herein.

In some embodiments, combinations of the above-described examples are employed. For example, a crosslinkable polyelectrolyte and nanoparticles are deposited and the bridging film is prepared by crosslinking the crosslinkable polyelectrolyte. In such a case, the nanoparticles may have a high or low aspect ratio (as defined above), or the nanoparticles may have a moderate aspect ratio provided that the crosslinked polyelectrolyte provides the barrier properties required of the bridging film (as described herein).

In some embodiments, the bridging layer is physically crosslinked. Physical crosslinking involves reversible crosslinks, such as crosslinks prepared from hydrogen bonding or other reversible bonds. Thus in some embodiments the bridging layer is a thermoplastic elastomer material. Unless otherwise specified, reference to a crosslinked material herein includes both chemical and physical crosslinking. Other physical crosslinking includes the formation of entanglements in a polymer melt. Entanglements exist for polymers with molecular weights above their entanglement molecular weight.

In some embodiments, the bridging layer is not crosslinked, but is of very high molecular weight (e.g., greater than 1 M Da), has a very high T_{g} (e.g., greater than about 200° C.), or is an interpenetrating polymer network (i.e., two polymers that are entangled at the molecular level, such as when two polymers are synthesized simultaneously in the same container).

An example material for a non-crosslinked bridging layer is PET. In some embodiments, when the bridging layer is PET, the bridging layer does not contact a porous film. For example, in some such embodiments, a hardcoat or other layer separates the PET layer from the porous film.

### BRIDGE LAYER CHARACTERISTICS

In some embodiments, the bridging films provide a non-porous or minimally porous barrier layer. Because the bridging film is non-porous or minimally porous, it provides a barrier against penetration by contaminants from adjacent films or materials into the layer that is protected by the bridge film.

By “minimally porous” is meant that the bridging film is less than 15% porous (i.e., less than 15% of the volume of the bridging film is occupied by pores), or less than 10% porous, or less than 7% porous, or less than 5% porous, or less than 3% porous, or less than 1% porous, or less than 0.5% porous, or less than 0.1% porous, or less than 0.01% porous. In some embodiments, the bridging film is substantially non-porous. In some embodiments, a closed-cell porous structure is suitable for the bridging films of interest (provided that the film maintains the properties of interest for the intended application). Unless otherwise specified, reference to non-porous bridging layers includes closed-cell porous bridging layers, provided that the closed-cell structure allows the bridging layer to function as described herein (i.e., forming a barrier against migration of contaminants, etc.).

The porosity of the bridging film can be controlled by selection of suitable materials as described herein. For example, selection of nanoparticles with a very large or very small aspect ratio provides bridging films that are minimally porous. More porous bridging layers can be provided, where desired, by using nanoparticles with less extreme aspect ratios. In some embodiments, for example, the permeability of the bridging layer can be tuned for the desired application by selection of materials that provide a suitable porosity.

In some embodiments, in addition to being non-porous or minimally porous, the bridging films of interest are substantially free of pinholes. Pinholes are voids or passageways that may be unfilled or filled (e.g., by a gas, liquid or solid material other than the film-forming material) and that extend entirely through the film, whereas pores are voids that may be filled or unfilled and do not extend entirely through the film. By “substantially free” is meant that pinholes cover less than 1% of the film area, or less than 0.1% of the film area, or less than 0.01% of the film area, or less than 0.001% of the film area, or less than 0.0001% of the film area. Alternatively, by “substantially free” is meant that there are fewer than 10 pinholes per μm², or fewer than 5 pinholes per μm², or fewer than 1 pinhole per μm². In some embodiments, pinholes have an average diameter of greater than 200 nm or greater than 300 nm, or greater than 500 nm, or greater than 1000 nm, or greater than 10 μm, or greater than 100 μm, or greater than 1 mm. In some embodiments, pinholes have an average diameter of less than 1 mm, or less than 100 μm, or less than 10 μm, or less than 1 μm, or less than 500 nm, or less than 300 nm. In some embodiments, pinholes have a diameter between about 100 nm and about 500 nm.

The thickness of the bridging film will depend, for example, on the materials used to form the film as well as the intended application. In some embodiments, the bridging film is as thin as 1 nm. In other embodiments, the bridging film can be as much as 1 mm in thickness. In some embodiments, for example, the bridging films are between about 1 nm and 50 μm, or between about 100 nm and 5 μm, or between about 500 nm and 3 μm. In some embodiments, the barrier films are less than 50 μm in thickness, or less than 25 μm, or less than 10 μm, or less than 1 μm, or less than 0.5 μm, or less than 0.1 μm. In some embodiments, the barrier films are greater than 100 nm in thickness, or greater than 500 nm, or greater than 1 μm, or greater than 5 μm, or greater than 10 μm.

The foregoing thicknesses are suitable for bridging films prepared from crosslinked materials, high molecular weight polymers, high or low aspect ratio nanoparticles, and combinations thereof. In some embodiments, where the bridging film is prepared from a low molecular weight polymer, as mentioned above the thickness of the bridging layer is greater to ensure that the bridging film retains the desirable properties described herein. For example, the bridging film is between about 2 nm and 100 μm, or between about 0.02 μm and 100 μm, or between about 0.02 μm and 10 μm. In other embodiments, it is not necessary to use a thicker bridging layer when employing a low molecular weight polymer.

In some embodiments, the bridging film is significantly thicker than the porous film that it contacts. For example, the bridging film is two times the thickness of the porous film, or 3 times the thickness of the porous film, or 5 times the thickness of the porous film, or 5 times the thickness of the porous film, or 10 times the thickness of the porous film. In some embodiments, the bridging film is significantly thinner than the porous film that it contacts. For example, the bridging film is equal to or less than one-half the thickness of the porous film, or less than one-third the thickness of the porous film, or less than 20% of the thickness of the porous film, or less than 10% of the thickness of the porous film, or less than 5% of the thickness of the porous film, or less than 1% of the thickness of the porous film, or less than 0.1% of the thickness of the porous film.

The density of the bridging film is determined by factors such as the material and method used to prepare the film, the presence of porosity, and the like. In some embodiments, the bridging film is denser than the porous film that it contacts. For example, the bridging film is 1.2 times the density of the porous film, or 1.5 times the density of the porous film, or 1.8 times the density of the porous film, or 2 times the density of the porous film, or 2.5 times the density of the porous film, or three times the density of the porous film. In some embodiments, the bridging film is less dense than the porous film that it contacts. For example, the bridging film is equal to or less than 90% of the density of the porous film, or less than 75% of the density of the porous film, or less than 60% of the density of the porous film, or less than 50% of the density of the porous film.

In some embodiments, the refractive index (RI) of the bridging film is selected to match the RI of the porous layer associated with the bridging film and/or the RI of an adjacent layer (i.e., the layer from which the porous layer requires protection). In some embodiments, the RI of the bridging film differs from the RI of either adjacent film by less than 50%, or less than 40%, or less than 30%, or less than 20%, or less than 10%.

In some embodiments, the polymer of the bridging film is chosen to provide or maintain a polar characteristic in the bridging film. By “polar characteristic” is meant to include full electrostatic charges, partial electrostatic charges, and/or molecular polarity (e.g., via polar functional groups such as carbonyl groups and the like, as described herein). It will be appreciated that, in some embodiments, electrostatic charge is dependent upon the pH of the material, and pH buffers or other modifiers are therefore suitable in deposition solutions (e.g. the solution of polyelectrolyte or nanoparticle used in a LbL deposition).

In some embodiments, the bridging film polymer is a hydrophilic material and/or a material that possesses a large enthalpy of hydration (e.g., <−1 kJ/mol) such that the material absorbs and/or retains water. Thus, in some embodiments, the polar characteristic is achieved by enabling the bridge film to retain water. In some embodiments, the polymer is an anionic polyelectrolyte. In some embodiments, the polymer is an anionic polyelectrolyte. Some examples of suitable polymer materials include a cyanoacrylate, shellac, polyvinylalcohol and polystyrene sulfonate.

Without wishing to be bound by theory, it is believed that the hydrophilic bridging films (i.e., bridging films comprising a hydrophilic polymeric material) serve as a partial or total barrier against migration of hydrophobic materials. For example, in some embodiments, the bridging film blocks migration of hydrophobic species out of a material layer adjacent to the bridging film. By “blocks” is meant to include complete prevention of migration, partial prevention of migration (e.g., reduction by 20%, or 30%, or 40%, or 50%, or 60%, or 70%, or 80%, or 90% compared to the material layer not adjacent to a bridging film), or a decrease in the rate of migration (e.g. a decrease by 20%, or 30%, or 40%, or 50%, or 60%, or 70%, or 80%, or 90% compared to the rate of rate of migration into a material layer not adjacent to a bridging film). In some embodiments, the hydrophobic species are plasticizers for polymeric materials such as polyvinyl butyral, polyvinyl chloride, and other plastic materials. Examples of plasticizers include phthalates such as dioctyl phthalate, or tri(ethylene glycol) bis(2-ethylhexanoate), as well as others described herein and still others known in the art.

In some embodiments, and as described herein above, the bridge film (either alone or as incorporated into a composite film) contains a certain amount of water. Such amount can be as much as 15 wt % or more at standard temperature and pressure. Without wishing to be bound by theory, it is believed that such water content helps to serve as a barrier against migration of hydrophobic small molecules such as plasticizers and the like, or as a barrier against migration of hydrophobic large molecules such as polymer molecules.

In some embodiments, the storage modulus of the bridge film is greater than the loss modulus. This relationship between the storage and loss moduli indicates that the bridge film material is not able to flow. These measurements are taken at a strain rate of about 1 rad/s at standard temperature and pressure.

### POSITIONING/LOCATION OF BRIDGE LAYER

In some embodiments, the bridging films of interest are part of a composite film. In such embodiments, the bridging film contacts one or more additional components of the composite film. The composite film may further contain (in addition to the bridging film) one or more porous layers, one or more substrates, one or more laminating layers/materials, one or more encapsulation layers, one or more additional bridging layers, and other component layers as desired.

In some embodiments, the bridging layer protects the film upon which the bridging film is disposed. For example, the bridging layer is disposed on a porous film, wherein the porous film is sensitive to degradation by small molecules and other materials. In such embodiments, the bridging layer serves as a barrier to prevent such small molecules and other materials from diffusing into the porous layer.

In some embodiments, the bridging layer is disposed on a porous film (also referred to herein as a porous material or a porous layer). For example, the porous film is disposed on a substrate and the bridging film is disposed over the porous film (i.e., further from the substrate). Alternatively, in some embodiments, the bridging layer can be disposed below a porous film (i.e., closer to the substrate). This is particularly applicable, for example, when the porous film must be protected from the substrate or from materials transporting through the substrate.

The porous layers of interest may be formed, for example, by a LbL method of deposition. The LbL method is described above with respect to the bridging layer. Accordingly, in such embodiments, the porous layer is prepared from two deposition materials, wherein the pair of deposition materials is complementary (e.g., having opposite electrostatic charges). Materials that are suitable for LbL preparation of porous films include metal oxide nanoparticles (e.g. titania, alumina, silica, cerium oxide, and the like, as well as combinations thereof), and polyelectrolytes (such as those described above with respect to the bridging material).

Porous films prepared by a LbL method are multi-layer films and may have a thickness, for example, that is less than about 5 μm, or less than 3 μm, or less than 1 μm, or less than 0.5 μm, or less than 0.1 μm, or less than 50 nm.

In some embodiments, the bridging layer is disposed adjacent to a porous material, wherein the porous material comprises nanoparticles but does not contain any organic polymeric material such as a polymer binder and/or a polymer polyelectrolyte. For example, in some embodiments the porous material is prepared using a LbL process, with nanoparticles and a polymer polyelectrolyte forming each bilayer, wherein the porous material is subsequently processed to remove the polyelectrolyte. In some such embodiments, after formation of the porous material (i.e., after formation of one or more bilayers), organic material such as polymer polyelectrolyte within the porous material is removed via pyrolysis, such as by heating the porous material to a calcination temperature. After such calcination the porous material remains porous but contains mostly or only inorganic materials, such as 75% inorganic materials, or 85% inorganic materials, or 95% inorganic materials, or 99% inorganic materials as measured by weight. The remaining inorganic materials include the materials described herein for use as nanoparticles, such as oxides of titanium, aluminum, cerium, zinc, iron, tin, silicon and the like. It will be appreciated that the calcination temperature used in the removal of organic material is lower than the sintering temperature of the inorganic material present in the porous material.

In some embodiments the porous layer comprises first and second nanoparticles, wherein the first and second nanoparticles are selected from the nanoparticle materials described herein. In some such embodiments, no polyelectrolyte polymer is used in preparing the film. For example, the first and second nanoparticles may have opposite charge and be present in alternating layers.

In some embodiments as mentioned herein, the bridging layer is disposed adjacent to a porous material. In some such embodiments, the porous material is not prepared using a LbL deposition method. For example, in some embodiments the porous material is a monolithic material. In some embodiments the porous material is a free standing film, such as a film of polycarbonate or another plastic material. In some embodiments the porous material is a coating prepared according to non-LbL methods, such as those mentioned herein (e.g., rod coating, etc.).

In some embodiments, the bridging film is disposed between a porous layer and an encapsulation layer. In some such embodiments, the encapsulation layer is a non-porous or minimally porous film that protects the porous layer (or anything underlying the porous layer) from environmental components such as water, oxygen, and the like, from mechanical degradation, or heat, light, UV or other energy related degradation. In some such embodiments, the bridging layer prevents materials from the encapsulation layer from reaching and entering the pores of the porous layer. Such materials include, as mentioned herein, structural materials (e.g., polymer), additives (e.g., plasticizers), contaminants, water, and the like.

In some embodiments, the bridging film is disposed between two porous films. For example, the bridging film can be disposed between a first set of bilayers forming a first porous film and a second set of bilayers forming a second porous film. In some embodiments, the first and second porous films have the same structure (i.e., they are formed from the same or similar materials and under the same or similar conditions). In some embodiments, the first and second porous films have different structures (i.e. they are formed from different materials and/or under different conditions). In some embodiments the first or second porous film contacts a substrate. In some embodiments, the first and second porous films both contact substrates, such that the substrates, first and second porous films, and bridging film form a laminated structure. In some embodiments, the bridging layer is disposed between two porous films that have different indices of refraction n1 and n2. For example, n1 is 10% greater than n2, or 20% greater, or 30% greater, or 50% greater, or 75% greater, or 100% greater. In some embodiments, the bridging layer is disposed between two porous films that have different thicknesses T1 and T2. For example, T1 is 20% greater than T2, or 50% greater, or 100% greater, or 2.5-fold greater, or 3-fold greater, or 5-fold greater, or 10-fold greater. In some embodiments, the bridging layer is disposed between two thin films wherein each film is a dichroic mirror. In some such embodiments, the dichroic mirrors have different peak reflectances. For example, one of the dichroic mirrors may have a reflectance range of 400-700 nm, whereas the other dichroic mirror may have a reflectance range of 700-1000 nm. When combined and separated by a bridging layer, the combined composite film may have a reflectance range of 400-1000 nm.

In some embodiments, the bridging film is disposed between a multilayer porous film (also referred to herein as a “porous film”) and a first laminating layer (the latter being made of a laminating material such as PVB, as described herein). In some such embodiments, the first laminating layer is disposed between (and laminates) the bridging film and a substrate such as a glass layer. Furthermore, in some such embodiments, the porous film is disposed on a substrate such as a plastic substrate (e.g., a PET substrate). Furthermore, in some such embodiments, the substrate upon which the porous film is disposed is itself disposed between the porous film and a second laminating layer (i.e., a layer of laminating material). Furthermore, in some such embodiments the second laminating layer is disposed between (and laminates) the substrate and another substrate such as a glass layer. An example of a composite film according to this embodiment has the following layers in order: glass, first laminating layer, bridge film, porous film, substrate or bridge film, second laminating layer, and glass. In such an example, the substrate can be, e.g., PET or hardcoated PET (i.e., PET having a crosslinked film disposed thereon).

In some embodiments, the bridging film is disposed between a multilayer porous film and an optically clear substrate. Examples of optically clear substrates include polymer substrates such as PET, polycarbonate, polyacrylates, triacetyl cellulose, PEN, and the like. Other examples include metal oxide substrates such as silicon dioxide (glass), indium tin oxide (ITO), and the like.

The bridging layer is, therefore, disposed between a porous film and a third layer, wherein the third layer is selected from a laminating layer, a porous film, an optically clear substrate, and an encapsulating layer.

In some embodiments, the bridging layer is itself a multilayer composite. For example, when the bridging layer is disposed between two porous films, the bridging layer can act as a lamination layer and may include a laminating adhesive layer as well as one or more barrier layers that protect the porous films from migration of adhesive material into the pores.

In some embodiments, multiple bridging films are used, and such films can be positioned in any suitable manner depending on the intended application. For example, a structure can be prepared having a substrate contacting a porous film, wherein the porous film is also contacting a bridging film. The bridging film is in turn contacting a laminating layer, and the laminating layer further contacts a second bridging film. The second bridging film contacts a second porous film, and the second porous film contacts a second substrate.

In some embodiments, the composite films containing a bridging layer as described herein are free standing films. That is, the composite films are not disposed on a substrate. In other embodiments, the composite films are disposed on a substrate. In some embodiments, the composite films are in the form of particles. For example, the composite films may be prepared on a substrate and then delaminated from the substrate as film particles. In some such embodiments, the bridging film is disposed between two porous films (i.e., a first porous film comprising bilayers of first and second polyelectrolytes, and a second porous film comprising bilayers of third and fourth polyelectrolytes, wherein the first and third polyelectrolytes may be the same or different, and wherein the second and fourth polyelectrolytes may be the same or different), and the bridging film thus provides a middle layer within the particles. In some such embodiments, the bridging layer is a weight-providing layer (described in more detail below), thereby increasing the weight of the particles relative to particles lacking the bridging layer. As described throughout this application, in some embodiments the bridging layer is disposed adjacent a first material, and also adjacent a second material from which the first material is to be protected. That is, the bridging layer is disposed between the first material and the second material. In some embodiments, the first material is a porous film as described herein. In some embodiments, the second material is a laminating layer or an encapsulation layer. In some embodiments, the second material is a metal coating such as a metal solar control film. In some embodiments, the second material is a paint such as a latex paint. Common to these second materials is the presence of a component that could diffuse into the porous film, potentially damaging or altering the properties of the porous film. Accordingly, the bridging layer provides protection against diffusion of materials into the porous film.

An example arrangement comprising the bridging films described herein is as follows. A porous film (free standing or not free standing) is sandwiched between two bridging films, such as two Aristoflex® films. The resulting trilayer film is then sandwiched between two laminating layers such as PVB layers. The resulting five-layer film can be prepared on a substrate or can be prepared as a free standing film. In addition, the resulting five-layer film can be sandwiched between two substrates such as two glass layers, thereby forming a dual-pane laminated glass composite with the porous film in the center.

### BRIDGING LAYER FUNCTION

In some embodiments, the bridging layer serves as a barrier layer to prevent migration of materials. For example, in embodiments wherein the bridging layer contacts a porous layer, the bridging layer prevents migration of materials into and through the porous layer from adjacent layers and/or the environment. Materials that the bridging layer can form a barrier against include gases, liquids, solids, vapors, photons or other electromagnetic energy, electrons, and protons. Some examples of such materials include water, oxygen, organic, ions, salts, acids, bases, solvents, encapsulating solutions, adhesives, plasticizers, and the like.

In some embodiments, the bridging layer serves to protect the porous film from mechanical degradation, optical degradation, and/or physical degradation, temperature, humidity or light induced degradation.

In some embodiments, the bridging layers of interest provide a physical barrier to material transfer, just as a traditional encapsulation layer provides a physical barrier to material transfer. However, such bridging layers can be distinguished from traditional encapsulation layers in one or more ways. For example, traditional encapsulation layers are monolithic layers that are not prepared via LbL deposition, whereas in some embodiments the bridging layers of interest comprise bilayers prepared via LbL deposition as described herein. Also for example, traditional encapsulation layers provide only a physical barrier to material transfer, whereas in some embodiments the bridging layers of interest provide a physical barrier as well as additional functionality (e.g. EM radiation reflection, filtering, etc.) as described in more detail herein.

In some embodiments, the porous film that contacts a bridging film of interest is an optical film. In such embodiments, the porous film has certain optical properties such as a refractive index of interest, or a reflectance v. wavelength profile of interest or the like. For example, in some embodiments, the porous film is a dichroic mirror, a Fabry-Perot etalon, a rugate filter, a Bragg filter, a bandpass filter, a gradient index anti-reflection coating, an antireflective coating, or the like. In some embodiments, the porous film selectively reflects EM radiation or acts as a selective EM filter. Such EM radiation may include infrared radiation, visible light, UV radiation, and combinations thereof. For example, the porous film selectively reflects EM radiation between 1-1000 μm, or 1-10 μm, or 10-100 μm, or 100-1000 μm. For example, the porous film selectively reflects thermal IR, near IR, and/or far IR radiation. For example, the porous film selectively reflects UV, such as between 1-400 nm, or 10-400 nm. In some embodiments, the porous film selectively reflects IR wavelengths and selectively passes visible, radio, and cellular wavelengths. By “selectively” is meant that the film reflects radiation within the selected range by a factor of 2, 5, 10, 20, 50, or 100 times more than radiation outside the selected range. Such selective reflection can be measured as an aggregate (i.e., reflection of all wavelengths within a selected range compared with all wavelengths outside the range or all wavelengths in a range that is outside the selected range) or as an average (i.e., average reflection within the selected range compared with average reflection outside the range). For example, the film reflects at least 90, 95, or 98% of incident IR but less than 10, 5, or 2% of other wavelengths (e.g., microwaves, radio, TV, cellular, and/or visible wavelengths).

In embodiments where the porous film is an antireflective coating the film has a minimum in % R at a desired wavelength, which can be controlled by selecting appropriate materials, thicknesses, etc.

In some embodiments, the porous film provides color to a composite. In some embodiments, the porous film will selectively reflect a portion of visible light. This yields a reflective color and a residual transmissive color. Any color can be provided by selecting bilayer properties (e.g., thickness, composition, etc.). For example, a film that reflects red and NIR radiation will look red. A film that blocks deeper in the NIR (e.g., λ₀=920 nm) will also have a harmonic reflectance in the blue, giving the film a blue color.

In some embodiments, the porous film has a maximum percent reflectance (% R) at a first wavelength (λ₁). In some embodiments, the porous film has a full-width at half maximum peak reflectance that is less than 200, 150, 100, 70, or 50 nm, or that is greater than 50, 100, 150, 200, or 300 nm. In some embodiments Xi is in the ultraviolet, infrared, or visible region of the spectrum. In some embodiments, the porous film has a % R at the first wavelength that is at least 50%, 75%, or 100% greater than the % R at any other wavelength in the visible range, ultraviolet range, and/or infrared range.

In some embodiments, the coatings of interest contain alternating layers of a high refractive index material and a low refractive index material. In some such embodiments, the difference between the high index and the low index may be greater than 0.1, 0.2, 0.3, 0.4, 0.5, 0.6, 0.7, 0.8, 0.9, or 1.0. In some embodiments, the refractive index of the high index material is greater than 1.75 or 2.0, whereas the refractive index of the low index material is less than 1.75 or 1.50, respectively. In some embodiments, the low refractive index is less than 1.4, 1.3, or 1.25. Alternating layers comprising titania and silica nanoparticles are an example of such a material.

In some embodiments, the porous film forms a multilayer photonic structure, wherein the bilayers are arranged to have optical interference effects.

In some embodiments, all or a portion of the thicknesses of the porous film layers are selected to be ⅛*λ₁ or ¼*λ₁ or ½*λ₁, wherein λ₁ is a predetermined wavelength in the visible, IR, or UV spectrum. In some embodiments, some of the thicknesses are non-harmonic relative to the predetermined wavelength A_{1.}

In some embodiments, the bridging layer serves as a barrier against migration of contaminants into the porous layer, wherein contaminants are materials that would damage the porous layer by their presence therein. For example, some small molecules (e.g., plasticizers, etc.) cause damage to the porous layer, even at low concentrations. Such damage includes mechanical damage, (e.g., decreasing or increasing elasticity, decreasing or increasing porosity, etc.)), optical damage (e.g., increasing or decreasing refractive index, reducing clarity, or altering absorption patterns), and physical damage (e.g., causing cracking, erosion, etc.). Contaminants therefore include small organic molecules, as well as other materials such as liquids, gases, water, salts, catalysts, and the like.

For example, the bridging layer is a barrier against migration of contaminants into the porous layer from a third layer. The third layer is a layer comprising a contaminant, and can be selected from a laminating layer (containing, e.g., plasticizers), a second porous layer (containing, e.g., ions), an optically clear substrate (containing, e.g., ions, plasticizers, or monomers), and an encapsulating layer (containing, e.g., plasticizers or monomers).

In some embodiments, the bridging layer serves as a barrier against migration of small molecules into a porous layer. The term “small molecule” as used in this context includes oligomers and refers to compounds having a molecular weight of less than about 1000 Da, including compounds having a molecular weight less than about 500 Da, less than about 400 Da, and less than about 300 Da.

In some embodiments, the bridging layer serves as a barrier against migration of material from adjacent lamination layers into the porous layer associated with the bridging layer. Such material includes film-forming material as well as solvents, plasticizers, and other components present in the lamination layer. Examples of solvents include organic solvents such as alcohols, amides, amines, ethers, and the like. Examples of plasticizers include: phthalates such as diisodecyl phthalate, di-n-octyl phthalate, diisooctyl phthalate, diethyl phthalate, diisobutyl phthalate, di-n-hexyl phthalate, butyl benzyl phthalate, bis(n-butyl)phthalate, diisononyl phthalate, bis(2-ethylhexyl) phthalate, and the like; trimellitates such as trimethyl trimellitate, n-octyl trimellitate, and the like; adipates such as dioctyl adipate, monomethyl adipate, dimethyl adipate, and the like; benzoates; maleates; hexanoates, sebacates; and the like.

For example, in some embodiments the bridging layer is positioned between a porous film and a laminating layer, wherein the laminating layer comprises a material selected from adhesives, pressure sensitive adhesives, hot melt adhesives, epoxies, thermosets, thermoplastics, elastomers, thermoplastic urethanes, and combinations or copolymers thereof.

In some embodiments, the laminating layer comprises PVB. The bridging layer, then, prevents material from the PVB layer from migrating into the pores of the porous film. A common material present in PVB layers is the plasticizer alkyl phthalates (such as dioctyl phthalate) or alkyl adipates (such as benzyl butyl adipate), and the bridging layers of interest are suitable for blocking migration of such materials out of the PVB layer.

In some embodiments, the bridging layer is disposed adjacent to a pressure sensitive adhesive (PSA) layer, and serves as a barrier against migration of materials from the PSA layer into other layers present in the composite. In some such embodiments, the barrier layer prevents passage of one or more materials present in the PSA layer, such as the PSA material itself and/or a plasticizer and/or another additive.

In some embodiments, the bridging layer serves as a barrier against migration of crosslinkable material. For example, when a crosslinkable encapsulation material is applied over a porous material to form a crosslinked encapsulation layer, a bridging layer positioned between the porous layer and encapsulation layer can prevent encapsulation material (either pre-crosslinked or post-crosslinked) or other material from the encapsulation layer from diffusing or otherwise migrating into the porous layer.

In some embodiments, the bridging layer serves as a barrier against migration into a porous layer of a hardening material. For example, certain hardening materials (e.g., crosslinkable materials or otherwise curable materials) are suitable as an encapsulation material. When such encapsulation materials are applied in pre-hardened form to a porous layer, the encapsulation material can migrate into the pores of the porous layer. In some embodiments, for example, this is desirable because encapsulation material becomes integral with the porous layer, thus increasing durability of the combined porous and encapsulation layers. However, in some embodiments, it may be desirable to limit migration of the encapsulation material to a certain depth of the porous layer. For example, replacement of air with an encapsulation material will result in a change in the refractive index, which can be either desirable or undesirable. Thus, at the desired depth, a barrier film according to the disclosure can be positioned. Such a structure can be produced, for example, by interrupting the normal deposition of the porous layers at the desired time with deposition of the bridging film. After deposition of the bridging film, deposition of the porous layers can continue until the desired film thickness has been obtained. Such a structure comprises a porous film below the bridging film (the “protected porous film”), a porous film above the bridging film (the “unprotected porous film”), and the bridging film itself. With such a structure, the encapsulation material is able to migrate into the unprotected porous layer (partially or completely) but is not able to penetrate the bridging film and so does not reach the protected porous film. Furthermore, as stated above, the permeability of the bridging layer can be tuned based on selection of film-forming materials. Thus, smaller amounts of encapsulation material (or other materials being transported) can be allowed into the protected porous film as desired. In general, the extent of protection provided by the bridging film for the protected porous film can be tuned as described herein by tuning the porosity of the bridging layer.

In some embodiments, the bridging film functions as a light-absorbing and/or light reflecting layer. For example, the bridging film can be prepared from a dark material such as a black absorbing material, or can be made dark or black by inclusion of a pigment or the like. In such embodiments, the bridging film protects the adjacent porous film (either partially or completely) from transfer of electromagnetic energy into the porous film.

In some embodiments, the bridging film functions as a proton-blocking layer. For example, in fuel cell applications the bridging films can be used in conjunction with a porous film as described herein to control the flow of protons. Materials suitable for bridging layers having proton-blocking properties include materials that are non-conductive to protons. Fuel cell applications may also employ bridging layers capable of blocking the flow of gases such as oxygen and hydrogen, and/or capable of blocking the flow of liquids such as water.

Similarly, in some embodiments, the bridging film functions as an electron-blocking layer. For example, in electronic device applications, the bridging film can be used in conjunction with a porous film as described herein to control the flow of electrons. In some embodiments, the bridging film functions as a high-K- or low -K dielectric layer. For example, in some embodiments, the bridging film functions to increase the dielectric breakdown potential for a composite film containing the bridging film (compared with a film not containing the bridging film but otherwise equivalent in thickness, etc.). That is, a composite film containing a bridging film according to the disclosure can withstand a higher applied electric field without suffering from dielectric breakdown compared with a similar film lacking a bridging film.

In some embodiments, the bridging film functions to increase the mechanical and/or thermal durability of the underlying porous film (or of a composite containing the bridging film). In some embodiments, the bridging film increases the resistance against abrasion of the porous film. In some embodiments, the bridging film is a crosslinked material that provides structural integrity to the composite. By “structural integrity” is meant the strength of the composite, resistance to degradation (abrasion, cracking, etc.), the ability to be deformed, or a combination thereof. Improved structural integrity can be measured by an increased T_{g} of the composite or of a component of the composite film or by a change in rheological properties of the film (e.g., an increase in the storage modulus). Also for example, the bridging film provides rigidity to the composite.

In some embodiments, the bridging film decreases the surface roughness of the porous film. In such embodiments, the exposed pores on the surface of the porous film result in surface roughness, and the bridging film acts to “fill in” or “bridge” such exposed pores. In such embodiments, the surface of the composite film (i.e. the porous film with a bridging film overlayer) has a lower surface roughness than the porous film without the bridging film.

In some embodiments, the bridging film provides extra weight in the composite film within which it is disposed. In some such embodiments, the weight-added composite is formed into particles (e.g., by delamination from a substrate) and the particles are heavier than similar particles lacking the bridging layer. In some such embodiments, the bridging film contacts a porous film and is the bridging layer is prepared from a material that is denser than the material forming the porous film. In some such embodiments, the bridging film is prepared from the same material forming the porous film, but the bridging film is less porous (e.g., non-porous) compared with the porous film. For example, in some embodiments, the bridging film is greater than 10% heavier (per unit volume) compared with the porous film upon which it is disposed, or greater than 20% heavier, or greater than 30% heavier, or greater than 40% heavier, or greater than 50% heavier, or greater than 100% heavier, or greater than 3-fold heavier, or greater than 5-fold heavier, or greater than 10-fold heavier, or greater than 25-fold heavier, or greater than 50-fold heavier, or greater than 100-fold heavier.

Thicknesses of the bridging film are described previously. Furthermore, in some embodiments, the bridging film is very thick (i.e., greater than 1 μm, 10 μm, 100 μm, or greater than 1 mm). In some such embodiments, as described in more detail herein, the bridging layer is prepared from a traditional (i.e., non-layer-by-layer) method such as spin coating, rod coating , slot-die coating or spray coating. For example, a 1 mm bridging layer may be deposited on a 1 μm porous film or between two 1 μm porous films. The bridging layer may be porous or non-porous, and may be denser or not denser than the porous layer(s). Thus, in some embodiments where added weight is desired, the density of the bridging film is the same (or even less) compared with the adjacent layer(s) but the bridging film is relatively thick compared with the adjacent layer(s).

In some embodiments, the bridging layer functions as a filtering layer and/or a reflective layer to electromagnetic radiation. Electromagnetic (EM) radiation includes, for example, light in the UV, visible, and IR regions of the EM spectrum. EM radiation also includes radiation in the radio, microwave, and higher frequency ranges. In some embodiments, the bridging layer functions as a barrier to any of the above-mentioned EM radiation. For example, in some embodiments, the bridging layer is an IR reflector layer. In some embodiments, the bridging layer is a UV reflector layer. In some embodiments, the bridging layer reflects both UV and IR wavelengths. Such reflectance characteristics can be obtained, for example, by preparing the bridging layer from a plurality of bilayers (prepared via LbL deposition), wherein the bilayers have suitable thicknesses and indices of refraction to act as dichroic mirrors or the like.

Combinations of the above-described functions may also be realized by the bridging layers of interest. For example, the bridging layer may function both as a weight-providing layer as well as a black absorbing layer, or as a light filtering layer (i.e. dichroic mirror) as well as a physical barrier layer to prevent the transfer of material to the adjacent porous layer.

### COMPOSITE FILM STRUCTURES

In some embodiments, the inventive composite films comprise, in sequence: a first porous film, a non-porous first bridging layer, and a third layer selected from first laminating layer, a second porous film comprising a plurality of bilayers, an optically clear substrate, and an encapsulating layer. In some embodiments, the inventive composite films further comprise any one or more of the following: a non-porous second bridging layer; a second optically clear substrate; a second laminating layer; a first hardcoat; and a second hardcoat. Any of these layers may further comprise an UV, visible or IR radiation absorbing material disposed within the layer. Examples of IR absorbing material include nanoparticles of indium tin oxide or lanthanum hexaboride.

In some embodiments where the first porous film is IR reflective, only those layers that are typically (i.e., during use of the composite film) shielded from direct sunlight by the first porous film will have IR absorbing material. As a result, the IR absorbing material is exposed only to incident IR radiation that is not reflected by the porous film. This reduces the amount of IR radiation that reaches the IR absorbing material (thus reducing the amount of heat generated by subsequent re-emission of the absorbed IR radiation). Examples of UV or visible absorbing materials include benzophenones, titanium dioxide nanoparticles, quantum dots, fluorescent dyes such as rhodamine or fluorescein. Other UV or visible absorbers can be found from BASF (i.e. Tinuvin brand of UV absorbers) or from QCR Solutions Corp. (i.e. UV381A or UV381B absorbing dyes or VSI503A or VIS548B visible absorbing dyes).

The above-mentioned additional may be arranged as appropriate for a given application, with the following as examples: a non-porous second bridging layer contacting the first porous film; an optically clear substrate contacting the first porous film; an optically clear substrate contacting the second bridging layer; a second bridging layer positioned between the first porous layer and a second laminating layer; a first optically transparent substrate contacting the first laminating layer and a second optically transparent substrate contacting the second laminating layer; a hardcoat contacting the second bridging layer; and an optically clear substrate contacting the third layer.

In some laminated embodiments, the inventive composite film comprises, in sequence, a first optically clear substrate (e.g., glass), a first laminating layer (e.g., PVB), a first bridging layer, a porous film, a second bridging layer, an optional second laminating layer (e.g., PVB), and an optional second optically clear substrate (e.g., glass). In some such embodiments, the porous layer provides for IR reflection. In some such embodiments, one or more of the second bridging layer, second laminating layer, and/or second substrate comprises an IR absorbing material.

In an embodiment, the inventive composite films comprise, in sequence, a laminating layer, a bridging layer, a porous film, a second bridging layer, and a second laminating layer. In such embodiments the laminating layers can both be PVB. In some such embodiments one or both of the second bridging layer and second laminating layer have an IR absorbing material. The composite may be disposed between first and second glass substrate layers.

In an embodiment, the inventive composite films comprise, in sequence, an optically clear substrate (e.g., glass), an adhesive layer, a first bridging layer, a porous layer, a second bridging layer, and a hardcoat. The first bridging layer can be PET. The hardcoat optionally comprises an IR absorbing material.

In some embodiments, the composite films comprise a low surface energy coating over the composite, or over a specific component of the composite such as a laminating layer, a porous film, or a bridging layer. Examples of a low energy surface include a fluorinated polymer (e.g., PTFE), stainless steel, PET, etc.

In some embodiments, the composite film comprises a sealant contacting the edge(s) of the composite. The sealant is a barrier material (i.e., any of the materials used for the bridging layer, such as crosslinked or high molecular weight materials, etc.) that prevents contaminants from traversing an edge of a bridging layer. For example, the sealant contacts the edges of a bridging layer, a third layer, and a porous film in a composite, and prevents migration of contaminants between the third layer and the porous film via the film/layer edges. Or, for example, the sealant contacts the edges of a bridging layer and the porous film such that there is no liquid or gas communication between the third layer and the porous film.

### PVB LAMINATING LAYERS

In some embodiments, the third layer of an inventive composite film (i.e., the layer separated from a porous film by a non-porous bridging layer) is a laminating layer. In some such embodiments, the laminating layer comprises PVB. The PVB layer is a film having two opposing sides, and in some embodiments at least one of the PVB sides is smooth. The second side of the PVB layer is selected from smooth and textured. By “smooth” is meant that the average peak to trough in a profile of the surface (e.g., as measured by profilometry) is less than about 10, 5, 4, 3, 2, or 1 μm. In contrast, a “textured” PVB surface that has an average peak to trough distance of greater than 10, 15, or 20 μm. In some embodiments, a textured side has features having a positive second derivative—i.e., the surface features are in the shape of spires rather than mounds or hills. In some embodiments, the textured surface has convex features.

In one aspect, the invention provides methods for preparing a PVB layer having one or both sides smoothed, and the PVB layers prepared via such methods. The method comprises contacting a textured PVB side with a smooth, hard substrate (referred to herein as a “smoothing substrate”) and applying pressure. Heat can be applied to the PVB layer before or during the contacting. The PVB layer can have one side smoothed via the process, by contacting the PVB layer against one smoothing substrate and one non-smoothing substrate. Non-smoothing substrates have a non-hard surface or a hard surface and allow the texture of a PVB surface to remain even when pressure and heat are applied. Examples are felt (with or without a ridged backing member such as glass) and Teflon coated fiberglass. The PVB layer can have both sides smoothed via the process, by contacting both sides of the PVB layer against smoothing substrates.

In one embodiment, the method for smoothing one or two sides of a PVB layer comprises passing a PVB layer between calender rollers (i.e., rollers configured to apply pressure to the PVB layer), or between a roller and a fixed surface. In such embodiments, the PVB can be heated before or during the contact with the rollers in order to facilitate deformation of the PVB surface(s). In one embodiment, the rollers or the roller and fixed surface are smooth, such that the resulting PVB layer has one or two smoothed surfaces. In some embodiments, one or more of the rollers has a texture such that the resulting PVB layer has one or two textured surfaces. Such texture may be a regular pattern (e.g., repeating peaks and troughs of known and fixed dimensions or may be a random arrangement of peaks and troughs. In both cases (i.e., smoothing a PVB surface or imparting roughness to a PVB surface), the method may be carried out in order to affect adhesion of the PVB to other surfaces. Adhesion may be improved or reduced, depending on the desired application.

The amount of heat necessary to apply to the PVB in the smoothing process varies with, for example, the amount of pressure applied and the glass transition temperature (T_{g}) of the PVB material. In some embodiments the heat supplied is at least the amount necessary to warm the PVB above the T_{g} of the material. The Tg of the PVB will depend on the molecular weight of the PVB as well as the presence or absence of other materials such as plasticizers, other polymers, etc. For example, a PVB layer having about 30% plasticizer has a T_{g} of about 60° C. In some embodiments, the PVB is warmed to a temperature above the material's T_{g}, such as 10, 20, 30, 40, 50, or more than 50 ° C. above T_{g}. For example, the PVB is warmed to about 100-300° C., such as 100, 150, 200, 250, or 300° C.

Where a smoothed surface is present in a PVB layer, the smooth surface can contact, for example, a bridging layer. The smooth surface allows formation of a smooth barrier layer (or allows improved adhesion with the barrier layer), and a smooth barrier layer allows formation of a smooth porous film. A textured surface, when present in a PVB layer, can contact, for example, an optically clear substrate.

### METHODS OF MAKING

The inventive composite films can be prepared either by depositing one layer atop another, by constructing free-standing layers and then applying one free standing layer to another free-standing layer, or by a combination of these methods (e.g., constructing two free standing films, each having multiple layers that were formed by depositing one layer atop another, and then applying the free standing films to each other).

In some embodiments, the inventive composites are prepared in a method comprising applying (i.e., depositing) the first bridging layer to the third layer, and then applying (i.e., depositing) the first porous film to the bridging layer in a layer-by-layer process. The method may further comprise depositing additional layers on the porous film and/or on the third layer. For example, a second bridging layer can be applied to the first porous film. Also for example, a second laminating layer can be applied to the second bridging layer. Also for example, an optically clear substrate can be applied to the first laminating layer, the second laminating layer, or both.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference.

### EXAMPLES

### Example 1; Porous Film Solution Preparation

100-200 k MW polydiallyldimethylammonium chloride (PDAC, 20 wt % solution) and tetramethyl ammonium hydroxide (TMAOH) were purchased from Sigma-Aldrich. 16.2g of PDAC was added to a plastic cup, containing about 100 ml of deionized water. A stir bar was added and mixed using a stir plate, set to 200 rpm for 5 minutes. PDAC solution was transferred to a larger container, until 16.2 g of PDAC was combined with 983.8 g of deionized water, for a total weight of 1000.0 g. The solution was then stirred for 30 minutes at 700 rpm on a stir plate. Finally the pH of the solution was adjusted to 10.0 by adding TMAOH.

Silicon dioxide nanoparticle dispersions (AS-40, Ludox™), tetraethyl ammonium hydroxide (TEAOH) and tetraethylammonium chloride (TEAC1) were purchased from Sigma-Aldrich. 1000g of deionized water was added to a plastic container being stirred at 500 rpm on a stir plate. TEAOH was added to the water until a pH=12.0 was achieved. 8.29 g of TEACl was then added to the water until all the salt was dissolved. 25.0 g of AS-40 was then added to the plastic container and left to stir for 5 minutes.

Titanium dioxide nanoparticle dispersions (X500) were purchased from Titan PE. 1000g of X500 was added to an empty plastic container. A stir bar was added to the container and stirred at 500 rpm. 8.29 g of TEACl was then added to 10 ml of deionized water in a separate 20 ml glass scintillation vial. The vial was closed tightly with a screw cap and shook until the salt was dissolved. Using a transfer pipette, the TEACl solution was added to X500 solution and stirred for an additional 5 minutes.

Rinse water was prepared by adding TMAOH to the deionized water until a pH of 10.0 was achieved.

### Example 2; Bridge Layer Film Solution Preparation

Aristoflex® AVC , an ammonium acryloyldimethyltaurate/VP copolymer (Clariant) was mixed with deionized water to a concentration of 0.1 wt %. The pH of the resulting solution was increased to around 10.0 with TMAOH.

6.5 k MW PDAC (denoted PDAC #1), 225 k MW PDAC (denoted PDAC #3), and 525 k MW PDAC (denoted PDAC #4) was obtained from Beckman Kenko and diluted to a concentration of 20 mM of the repeat unit. The pH of the resulting solutions were adjusted using TMAOH to a pH of 10.0. 100-200k MW PDAC was prepared as detailed in Example #1 (denoted PDAC #2). A poly(acrylamide-co-diallyldimethylammonium chloride) 10 wt % solution (denoted copolymer) was purchased from Sigma Aldrich, and was diluted to either 5 mM or 10 mM of the diallyldimethyl ammonium chloride repeat unit with TMAOH added until a pH of 10.0 was achieved.

### Example 3; Layer-by-Layer Deposition of Porous Films as Optical Films

Optical films were deposited onto polyethylene terepthalate plastic film (PET, Melinex 454, Dupont Teijin) using a deposition system modeled after the systems described in US Patent Application Publication No. US 2010/0003499 to Krogman et al., as well as Krogman et al., Automated Process for Improved Uniformity and Versatility of Layer-by-Layer Deposition, Langmuir 2007, 23, 3137-3141. Eighteen PDAC-X500 bilayers (i.e. cycles of PDAC-rinse-X500-rinse applied to the surface) were deposited to the substrate for the formation of a high index film (HI). Eleven PDAC-AS40 bilayers (i.e. cycles of PDAC-rinse-AS40-rinse applied to the surface) were deposited for the formation of a low index film (LO). These numbers of bilayers were selected to create quarter wavelength optical thickness (QWOT) stacks for a λ₀=880 nm wavelength design. A 7-film architecture consisting of substrate-HI-LO-HI-LO-HI-LO-HI was used to create the optical dichroic mirror. Reflectance measurements were made on a UV-Vis spectrophotometer (Shimadzu 3101) with data shown in FIG. 1, with backside absorbing electrical tape applied to the back of the PET substrate.

Bridge films were constructed by forming bilayers of (PDAC/Aristoflex)ₙ, where n denotes the number of bilayers for the bridge films. The bridge films were deposited onto the optical films using the same system used for depositing the optical films. The presence of the bridge layer does not substantially alter the optical behavior of the underlying multilayer porous film. Indeed the presence of (PDAC/Aristoflex)₇ bridge layer exhibits no variation in the optical spectrum relative to the porous film. The peak reflectance remains the same at about 80%. (PDAC/Aristoflex)is and (PDAC/Aristoflex)₂₀ exhibit a minor shift in the λ₀ to 884 nm. No variation in the optical spectra is observed despite varying the number of bilayers, and thus the thickness of the bilayers.

### Example 4; Lamination Between Pieces of Glass

The laminated structure was formed by sandwiching the PET-multilayer porous film-bridge layer stack (from example 3) between two pieces of polyvinyl butyral (PVB,) and further sandwiched between two pieces of borosilicate glass. The assembly had the following layers in order: felt, glass, laminating material, bridge film, porous film, substrate, laminating material, glass and felt. The felt layers were used for protecting the glass layers and were not part of the final composite (although felt may be retained in place as long as desired). The assembly was sandwiched with several vise clamps until an approximate pressure of 175 psi was achieved. The clamped assembly was then heated to 130° C. in a furnace for 30 minutes and subsequently allowed to cool. The felt layers were then removed to provide an assembly having the layers glass, laminating material, bridge film, porous film, substrate, laminating material, and glass.

The presence of the PVB results in a change in the optical spectra, with the peak reflectance decreasing from about 80% to about 72% at 880 nm, with no accompanying shift in λ₀. This is wholly to be expected due to the incorporation of the PVB as an additional part of the optical stack, which can be accounted for using optical simulation tools. To demonstrate that this decrease is not due to infiltration of PVB or the plasticizer in the PVB into the pores of the optical stack, we simulated the optical effect of PVB disposed upon the porous film without infiltration, using an optical modeling package (TFCalc). The experimentally obtained optical spectra matched up exactly with the predicted simulation, indicating that the PVB did not infiltrate into the porous film. Thus the bridge film protected the underlying porous film from permeation of the PVB into the pores.

The thickness of the bridge layer has a direct impact at blocking permeation of the plasticizer or PVB. For the case of no bridge layer disposed on the porous film, the peak reflectance at 880 nm decreases from 80% to about 52%. The presence of (PDAC#2/Aristoflex)₇ mitigates the permeation to some degree and the corresponding peak reflectance is about 63% . Using (PDAC#2/Aristoflex)₁₅ recovers the peak reflectance to 70%, of the case of no permeation and matches the effect of (PDAC#2/Aristoflex)_{20.} This is also consistent with the expected spectra obtained from optical simulation when accounting for the presence of the PVB. The growth rate of (PDAC#2/Aristoflex) is approximately 4.4 nm/bilayer.

Increasing PDAC molecular weight had a strong effect on the bridge layer's ability to prevent permeation. 5 or 10 bilayers of a particular polycation/Aristoflex bridging layer was deposited onto porous films The bilayer growth rates (in nm per bilayer, denoted nm/bl) of the bridge film are shown in Table 1. We observed that higher molecular weight PDAC can blocked permeation with 5 bilayers. (PDAC#4/Aristoflex)s or (PDAC#3/Aristoflex)₅ maintained the peak reflectance expected from the optical model whereas 5 bilayers of PDAC#2, PDAC#1, or the copolymer with Aristoflex exhibited a dramatic reduction in peak reflectance . We also demonstrated that increasing thickness improved the efficacy of the bridge layer. For lower molecular weight PDAC good efficacy as a bridge film was obtained when 10 bilayers were deposited. (Copolymer/Aristoflex) films were also used as bridge layers and in general perform poorly compared with (PDAC/Aristoflex) films. However given sufficient thickness and a higher concentration of copolymer, permeation can be mitigated.

TABLE 1
Growth rate of bridge layers in nanometers per bilayer.

| Polycation | Aristoflex concentration | growth rate [nm/bl] |
|---|---|---|
| PDAC #4 | 0.1 wt % | 1.0 |
| PDAC #4 | 0.1 wt % | 5.8 |
| PDAC #3 | 0.1 wt % | 6.0 |
| PDAC #2 | 0.1 wt % | 4.4 |
| PDAC #1 | 0.1 wt % | 2.5 |
| copolymer | 0.1 wt % | 1.1 |

### Example 5; Clay Based Nanocomposites for Bridge Film

Polyallylamine hydrochloride (PAH) was purchased from Beckman-Kenko as a 28 wt % solution in water. PAH solutions were prepared by adding 2.4 g of PAH solution to 1 liter of deionized water and stirring. Final solution pH was adjusted with NaOH until a pH of 9.0 was achieved.

Clay particles (RXG7203) were obtained from Southern Clay Product. 25 g of RXG7203 was mixed with 1 liter of deionized water, premixed with NaOH to achieve a pH of 10.2 in the final solution. The clay suspension was mixed in a blender for 2 minutes followed by 2 rounds of ultrasonication for 10 minutes each. Sodium chloride was added to the suspension to final concentration of 10 mM NaCl.

Rinse solution was prepared by adding NaOH to deionized water until a pH of 9.0 was achieved.

Bridge films were deposited onto silicon wafers using a deposition system modeled after the systems described in US Patent Application Publication No. US 2010/0003499 to Krogman et al., as well as Krogman et al., Automated Process for Improved Uniformity and Versatility of Layer-by-Layer Deposition, Langmuir 2007, 23, 3137-3141. 25 bilayers of (PAH/RXG7203) were applied on top of the 2 bilayers of PAH/PSS. The film thickness was measured to be around 240 nm by scoring the film with a razor blade and using a Tencor AlphaStep touch profilometer.

### Example 6; Rod-Coated Polyelectrolyte or Crosslinkable Bridge Films

The surface of a rod coat table was wiped with paper towel, the top edge of the optical film (described in Example 3) was taped and the wirebound rod (#8) was brought into close contact with the substrate. 1-2 ml of either a commercially available acrylate-containing UV crosslinkable hard coat formulation (obtained from ISTN Inc) or Aristoflex formulation (1.2% by weight in a solution of 50% w/w water/ethanol) was pipetted evenly against the rod as a line. At a speed setting of 3, the bridge film solution was applied to the optical film forming a composite film. For the Aristoflex formulation, the composite film was allowed to rest overnight. For the hard coat formulation, the composite film was taped to a 6″ wide piece of glass. The sample was then run through an inline UV conveyor system (Fusion) at a conveyor speed of 5 in order to UV-cure the hard coat. The hard coat was laminated in the method of Example 4, and exhibited no degradation in optical properties.

### Example 7; Smoothing PVB

The surface roughness of two-sided textured polyvinylbutyral (PVB) sheets (0.76 mm thick) was measured using a Tencor P-10 profilometer. The data obtained showed a representative peak to trough distance of about 20-25 microns. Peak to peak distances varied from about 0.1 mm to about 0.2 mm. The PVB was then placed between two sheets of 3 mil PET (Tekra) that were used as release liners. The PET-PVB-PET sandwich was then placed between two pieces of float glass and felt. The assembly was clamped together with a c-clamp forming a full stack having the following composition: felt-glass-PET-textured PVB-PET-glass-felt. The clamped assembly was placed in a furnace at 150° C. for 30 minutes at an estimated clamping pressure of 150 psi. The assembly was removed from the furnace and allowed to cool to room temperature. The felt/glass/PET was removed from both sides of the PVB. The surface roughness of the “smoothed PVB” was measured on the profilometer. No peak to trough distances greater than about 1 μm in height were observed. An alternative smooth PVB, obtained from a supplier, was also measured as a reference, and showed peak to trough distances of about 10 μm.

### Example 8; One Sided Smooth PVB

One sided smooth PVB was created by sandwiching textured PVB between a sheet of 3 mil PET on one surface and a Teflon coated fiberglass non-stick baking sheet (Williams Sonoma) on the other surface. The Teflon coated fiberglass was selected to maintain roughness on one side after the melt-press process described in the example above. The assembly was sandwiched between glass and felt, clamped together, and heated as per the process described in Example 7. After cooling and removal of the release liners, the surface roughness was measured on both sides. The smooth side exhibited peak to trough distances of less than 1 μm. The textured side showed a magnitude of roughness of approximately 20 microns, similar to the original textured surface of the PVB. The texture of the textured side had a positive second derivative—i.e., spires (rather than mounds or hills).

### Example 9; Bridge Coating for Smoothed PVB.

UV Film liquid (ASC 365) was applied to the surface of the one-sided smoothed PVB using a Meyer rod coater. The coated PVB was placed on a piece of glass and passed through a Fusion UV curing system at a belt speed of 3. The UV Film liquid was crosslinked based on the rigid feel of the coating. Measurements using nanoindentation confirmed crosslinking (data not provided).

### Example 10; LbL Coating on Bridge Coated PVB

The coated, smoothed PVB from Example 9 was used as a substrate. Optical films were deposited onto this substrate using a deposition system modeled after the systems described in US Patent Application Publication No. US 2010/0003499 to Krogman et al., as well as Krogman et al., Automated Process for Improved Uniformity and Versatility of Layer-by-Layer Deposition, Langmuir 2007, 23, 3137-3141. Eighteen PDAC-X500 bilayers (i.e. cycles of PDAC-rinse-X500-rinse applied to the surface) were deposited to the substrate for the formation of a high index film (HI). Eleven PDAC-AS40 bilayers (i.e. cycles of PDAC-rinse-AS40-rinse applied to the surface) were deposited for the formation of a low index film (LO). These numbers of bilayers were selected to create quarter wavelength optical thickness (QWOT) stacks for a 880 nm wavelength design. A 7-film architecture consisting of substrate-HI-LO-HI-LO-HI-LO-HI was used to create the optical dichroic mirror.

### Example 11; Second barrier coating on LbL coated bridge coated PVB

UV Film liquid (ASC) was applied to the surface of LbL film of example 8 (one sided smoothed PVB) using a Meyer rod coater. The coated PVB was placed on a piece of glass and passed through a Fusion UV curing system at a belt speed of 3. The UV Film liquid was crosslinked based on the rigid feel of the coating. The resulting film stack consisted of PVB, a bridge film, a multilayer porous film and another bridge film. A sheet of PVB was placed upon the stack and then, sandwiched on both sides between Teflon coated fiber glass/glass/felt, c-clamped and heated in the manner of Example 7. The stack was cooled, the felt, glass and fiberglass were removed, resulting in a free standing textured PVB interlayer with an IR reflecting multilayer porous film embedded inside. To create laminated safety glass, the textured PVB interlayer was then sandwiched between two pieces of glass and felt, clamped and heated to 150° C. for 30 minutes. The assembly was then cooled and the felt was removed, leaving behind a laminated safety glass with an IR reflecting multilayer porous film embedded inside.

### Example 12; Continuous 1 Sided Texturing

A set of calendering rollers are used to apply pressure to heated PVB. The PVB may be textured or smooth to start on a single side of each or on both sides of either. Prior to contact with the calendering rollers, the PVB is heated to temperatures above the glass transition of the PVB, which is dependent on the amount of plasticizer in the PVB. The heated, flowable PVB comes into contact with the chill rollers and heat is transferred from the PVB to the rollers. The PVB vitrifies and takes on the shape of rollers. In one example, a smooth chill roller and a textured chill roller are used to apply pressure to a 2 sided smooth PVB layer. The result after passing through the rollers is a 1-sided smooth PVB layer (i.e., the side contacting the smooth roller remains smooth, while the side contacting the textured roller becomes textured).

### Example 13; Barrier Films for Pressure Sensitive Adhesives

An IR reflecting optical film of example 3 is deposited onto the surface of 1 mil PET with a pressure sensitive adhesive and release liner on the side opposite the optical film. The optical film is then coated with a barrier layer of example 6 and subsequently cured using UV. The optical film is then laminated via pressure sensitive adhesive, to hardcoated PET, where the hardcoat contains IR absorbing lanthanum hexaboride nanoparticles such that the film architecture is release liner-pressure sensitive adhesive-1 mil PET-optical film-barrier layer-pressure sensitive adhesive-PET-LaB₆ containing hardcoat. The release liner is removed and the film is applied to the interior of a window to provide color and solar control.

What is claimed is:

1. A composite comprising, in sequence:
(a) a first porous film comprising a layer by layer deposited film;
(b) a non-porous first bridging layer; and
(c) a third layer selected from a first laminating layer, a second porous film comprising a plurality of bilayers, an optically clear substrate, and an encapsulating layer,
wherein the first bridging layer forms a barrier against transmission of contaminants, EM radiation, electrons, or ions, into the first porous film from the third layer, or wherein the first bridging layer provides structural integrity to the composite.

2. The composite of claim 1, wherein the first porous film comprises layers of nanoparticles alternating with layers of polyelectrolyte.

3. The composite of claim 1, wherein the first bridging layer is chemically crosslinked, physically crosslinked, or is not crosslinked.

4. The composite of claim 1, wherein the contaminant is selected from small organic molecules, water, ions, salts, acids, bases, liquids, and gases.

5. The composite of claim 1, wherein the third layer is a first laminating layer.

6. The composite of claim 5, wherein the first laminating layer comprises PVB having a first smooth side and second side selected from smooth and textured.

7. The composite of claim 5, comprising an optically clear substrate contacting the first porous film.

8. The composite of claim 5, comprising a non-porous second bridging layer contacting the first porous film.

9. The composite of claim 8, comprising an optically clear substrate contacting the second bridging layer.

10. The composite of claim 8, wherein the second bridging layer is positioned between the first porous film and a second laminating layer.

11. The composite of claim 10, comprising a first optically transparent substrate contacting the first laminating layer and a second optically transparent substrate contacting the second laminating layer, wherein the second optically transparent substrate optionally comprises an EM absorbing material.

12. The composite of claim 1, wherein a PET layer is not contacting the first porous film.

13. The composite of claim 1, comprising a non-porous sealant contacting the edges of the first porous film, the first bridging layer, and optionally the third layer.

14. A method for forming the composite film of claim 1, the method comprising:
applying the first bridging layer to the third layer;
curing the first bridging layer to form a first crosslinked hardcoat; and
applying the first porous film to the bridging layer in a layer-by-layer process.

15. The method of claim 14, comprising applying a non-porous sealant to the edges of the first porous film, the first bridging layer, and the third layer

16. A method for making a modified PVB layer, the method comprising heating a PVB layer to above the T_{g} of the PVB contacting a first side of the PVB layer with a smooth surface, contacting a second side of the PVB layer with a second surface, and applying pressure to the PVB layer.
